(19) United States
(12) Patent Application Publication
(10) Pub. No.: US 2009/0327592 A1
(43) Pub. Date: Dec. 31, 2009

(54) CLUSTERING DEVICE FOR FLASH MEMORY AND METHOD THEREOF

(75) Inventors: Ji Woong CHANG, Seoul (KR); Se Mi Park, Seoul (KR); Duck Ho Bae, Seoul (KR); Sang Wook Kim, Seoul (KR)

Correspondence Address: LEXYOUME IP GROUP, LLC, 5180 PARKSTONE DRIVE, SUITE 175, CHANTILLY, VA, 20151, US

(73) Assignee: KOREA POLYTECHNIC UNIVERSITY Industry and Academic Cooperation Foundation, Siheung-si (KR)

(21) Appl. No.: 12/493,346

(22) Filed: Jun. 29, 2009

(30) Foreign Application Priority Data
Jun. 30, 2008 (KR) 10-2008-0062735

(51) Int. Cl. G06F 12/00; G06F 12/02

(52) U.S. Cl. 711/103; 711/E12.001; 711/E12.008

(57) ABSTRACT

Disclosed are a clustering device for a flash memory and a method thereof. The clustering device for a flash memory in accordance with an embodiment of the present invention can gather pages having similar update times and perform a write operation of the pages in a same block. Accordingly, the writing performance of the flash memory can be improved and the lifetime of the flash memory can be increased.

### BACKGROUND

1. Technical Field

The present invention relates to a clustering device for a flash memory and a method thereof, more specifically to a clustering device for a flash memory and a method thereof that can minimize a block copy cost.

2. Description of the Related Art

Flash memories are popular as storages for portable electronic devices because of their properties such as low power consumption, non-volatile, and portability. The flash memory has a plurality of successive blocks having the same size, and one block has a plurality of successive pages having the same size. The flash memory can carry out read, write, and erase operations. At this time, in the flash memory, the read and write operations are performed per page and the erase operation is performed per block.

Such flash memories have their inherent properties as contrasted with typical storage such as discs. For example, while the disc has no difference in the speeds of performing the read and write operations, the flash memory has the difference in the speeds of performing the read and write operations. That is, the write operation has the slower performing speed than the read operation in the flash memory. Secondly, the flash memory has the new operation, which is the erase operation, but the typical storages have no erase operation. It is impossible that the flash memory performs the in-place update of stored data due to its physical properties. To update the stored data, the flash memory uses the method of invalidating a page in which the data is stored and storing another page, in which updated data is stored, at another area. At this time, the previous page is invalidated by the erase operation. Before the erase operation is performed, it must be preceded that the valid data in a pertinent block is copied to another block. This is called “block copy.” As such, the erase operation has very large overhead, which is caused by the frequently performed writing operation. In addition, in the case of the flash memory, the frequencies that the erase operation is able to be performed at one block is typically limited to one billion times or less. The block, in which the erase operation has been already performed one billion times and more, is not usable any more. That is, the frequent performance of the erase operation causes the lifetime of the flash memory to be shortened. Accordingly, it is very important to reduce the performance of the erase operation in the flash memory.

In order to reduce the performance of the erase operation, a hot data clustering method is suggested, which stores the frequently updated data in the same page or block. Here, hot data refers to the frequently updated data. The page storing the hot data is easy to be invalidated because the update is frequently performed. Accordingly, if the pages of the hot data are stored in the same block, it is possible to reduce the copy cost of the pertinent block when the erase operation is performed. This causes the frequency of performing the write operation and the frequency of performing the erase operation to be decreased. Thus, the general efficiency of the flash memory is improved. However, even though hot data is gathered in a certain block, there may be many valid pages in the block when the erase operation is requested. For example, it is assumed that one block has a total of 8 pages, each page has the same period of 3, and hot data is stored per page. Then, with the passage of time, pages are successively written in the block. When the erase operation is requested at T5, the block has three invalid pages 0 through 2 and four valid pages 3 through 6. At this time, if the erase operation is performed, the 4 valid pages must be copied to another block. This causes expensive block copy cost and also the copy to be frequently performed, thereby lowering the efficiency of the flash memory and inducing frequent performance of the erase operation. Accordingly, the lifetime of the flash memory is shortened.

### SUMMARY

The present invention, which is contrived to solve the aforementioned problems, provides a clustering device for a flash memory and a method thereof that can improve the performance of a write operation of the flash memory and increase the lifetime of the flash memory.

A clustering device for a flash memory can gather pages having similar update times and perform a write operation of the pages in a same block.

If there are some data having different update periods in a same page, an update period of the page can become identical to that of data having a shortest update period.

The clustering device for a flash memory can include an allocator, configured to allocate a page that is to store data on the basis of a group management table, if a write operation is requested; and a cleaner, configured to erase a block selected by an erase policy, if an erase operation is requested.

The group management table can manage a plurality of group entities and comprises a group update time and a list of the blocks of the group.

The group can be a set of blocks storing pages having similar update times, and one group can correspond to one group management table entry.

If a page Pj is updated, the page Pj can be stored at a group entry Ei that satisfies the following formula:

Eᵢ₋₁.updatetime<Pⱼ.updatetime≦Eᵢ.updatetime

A clustering method for a flash memory can include checking whether data writing is new data writing or previous data updating, if the data writing is requested; invalidating a page in which previous data has been stored and calculating an update time of a pertinent page, if it is checked that the data writing is the previous data updating; checking whether there is a blank page in a group corresponding to the calculated update time, if there is the group; and storing the updated data at the blank page if there is the blank page.

The clustering method for a flash memory can further include allocating a new block and adding the block into the group, if there is no blank page. In this case, the updated data can be stored at a blank page of the added block.

The clustering method for a flash memory can further include storing the updated data at a blank page of a block that is not included in the group, if there is no group entry corresponding to the calculated update time.

If it is checked that the data writing is the new data writing, the data can be stored at a blank page of a block that is not included in the group entry.

A clustering method for a flash memory can include invalidating a page in which previous data has been stored and calculating an update time of a pertinent page, if data writing is requested; and checking whether there is a group corresponding to the calculated update time and storing updated data at a blank page if there is the group.

The clustering method for a flash memory can further include allocating a new block and adding the allocated block into the pertinent group, if there is no blank page in the pertinent group.

The clustering method for a flash memory can further include storing the updated data at a block that is not included in the group, if there is no pertinent group.

### BRIEF DESCRIPTION OF THE DRAWINGS

FIG. 1 shows an example in which block copy is performed in a hot data clustering operation;

FIG. 2 shows how a clustering method for a flash memory is performed in accordance with an embodiment of the present invention;

FIG. 3 shows an example of a page having data of different update periods;

FIG. 4 shows the structure of a clustering device for a flash memory in accordance with an embodiment of the present invention;

FIG. 5 is a flowchart showing a general write operation of a clustering method for a flash memory in accordance with an embodiment of the present invention;

FIG. 6A and FIG. 6B show a write operation when the update time of a write-requested page corresponds to an entry in a group management table;

FIG. 7 is a graph showing the frequency of data having the locality;

FIG. 8 is a graph showing an average block copy cost according to the locality;

FIG. 9 is a graph showing the total frequency of an erase operation according to the locality;

FIG. 10 is a graph showing an erase cost according to the locality;

FIG. 11 is a graph showing an average block copy cost according to the number of groups;

FIG. 12 is a graph showing the total frequency of an erase operation according to the number of groups;

FIG. 13 is a graph showing an erase cost according to the number of groups;

FIG. 14 is a graph showing an average block copy cost according to an update time interval of group;

FIG. 15 is a graph showing the total frequency of an erase operation according to an update time interval of group; and

FIG. 16 is a graph showing an erase cost according to an update time interval of group.

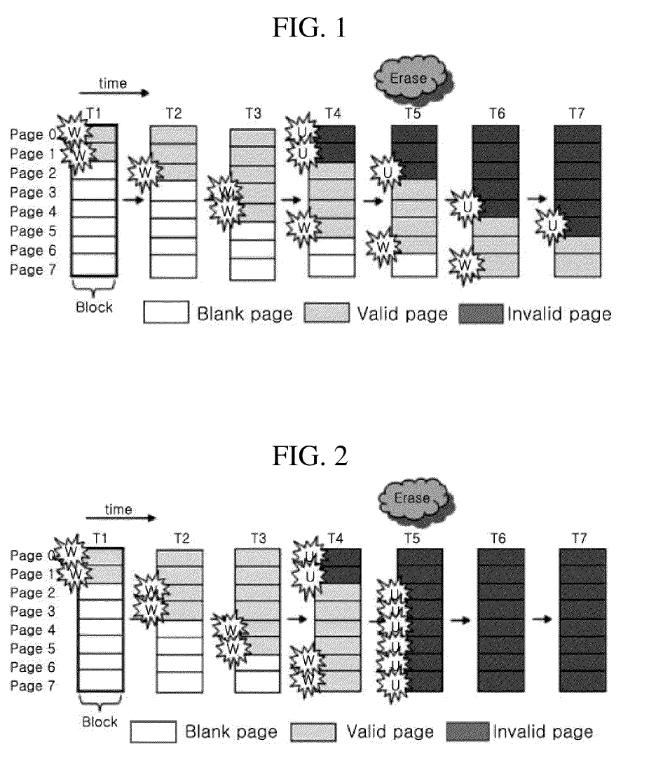

### DETAIL DESCRIPTION

Hereinafter, a clustering device for a flash memory and a method thereof in accordance with an embodiment of the present invention will be described with referenced to the accompanying drawings.

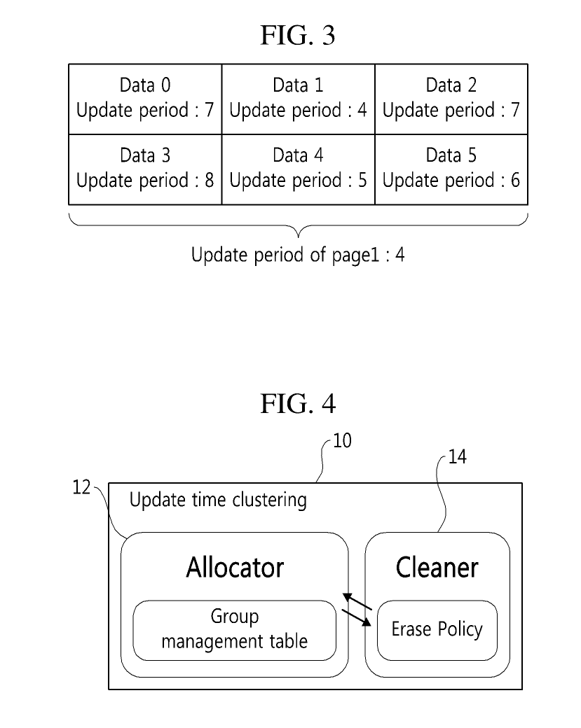

FIG. 2 shows how a clustering method for a flash memory is performed in accordance with an embodiment of the present invention. It is assumed that one block has a total of 8 pages and all pages were updated before T5. At this time, each updated page can be clustered on the basis of update time. The update time of page refers to an expected time at which a pertinent page will be updated. The update time of page can be expected on the basis of the data having the shortest period among data having the update periods in the pages. For example, if it is assumed that there are 6 data having different update periods in one page as shown in FIG. 3, then the update time of page can be expected on the basis of data 1 having the shortest period of 4. In order to reduce the block copy cost, the number of the valid pages in the pertinent block that performs the erase operation must be smaller. Accordingly, the data having similar update times can be stored in the same block in accordance with an embodiment of the present invention. That is, if a next update time is known when a page is update, the page can be written in the block having the expected update completion time, which is the most similar to the update time of the page. The expected update time of a page refers to an expected time at which a next update will be performed after a page is completely updated. The update completion time of block refers to a time directly after all the pages of the pertinent block were completely updated. Thus, the clustering method on the basis of the expected update time according to an embodiment of the present invention is the method of storing pages in consideration of the expected update times of the pages on the basis of the expected update completion time of block.

If the pages having the different update periods but the similar expected update times are written in the same block, all the pages of the block may be invalid after the update completion time. At this time, if the erase operation of the block having the invalid pages is performed at the T5, the block copy cost can be significantly decreased.

FIG. 4 shows the structure of a clustering device for a flash memory in accordance with an embodiment of the present invention. A clustering device 10 in accordance with an embodiment of the present invention can roughly include allocator 12 and a cleaner 14.

The allocator 12 can allocate a page to store data when the write operation is requested and mange a group management table to allocate pages. Here, the group management table refers to a table that manages blocks per group to allocate areas at which updated pages are to be stored.

A group refers to a set of blocks storing pages having the similar update time. One group can correspond to one group management table entry. The group management table can manage a plurality of group entries. One group entry can include a group update time and a list of the blocks of the group. The group update time refers to a maximum value of the update times of the pages written in the pertinent group.

If a certain page Pj is updated, the Pj will be stored in a group entry Ei, which satisfies the following formula 1:

Eᵢ₋₁.updatetime<Pⱼ.updatetime≦Eᵢ.updatetime [Formula 1]

As time goes by, the group entry having the update time that is before the current time may be erased in the table and a new group entry can be created. At this time, the update time of the group entry can be automatically given by a predetermined update time interval. A user can determine the update time interval according to data type. If the update time interval is widely determined, this may increase the update time intervals of the pages which are to pertain to the same group. Accordingly, when the erase operation is performed, there is much possibility that there are many valid pages in the pertinent block, thereby increasing the block copy cost. In contrast, if the update time interval is narrowly determined, this may enable the group update time to be subdivided, thereby decreasing the number of the pages which are to pertain to the same group. Accordingly, many blocks having a lot of blank pages may be erased. Thus, it is important to determine an adequate value.

When the erase operation is requested, the cleaner 14 can erase blocks selected by the erase policy. The possibility that a block is selected may be increased as there are more invalid pages and less valid pages in a certain block and there are less frequencies that the erase operation is performed.

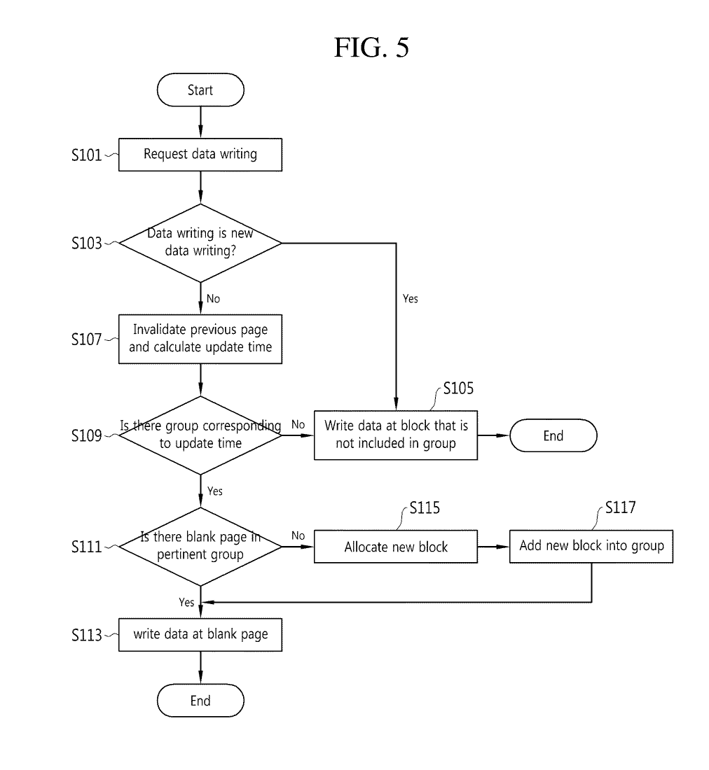

FIG. 5 is a flowchart showing a general write operation of a clustering method for a flash memory in accordance with an embodiment of the present invention. The clustering method for a flash memory in accordance with an embodiment of the present invention will be described in more detail with reference to FIG. 5.

If data writing is requested, the clustering device 10 can check whether the requested data writing is new data writing or previous data updating by comparing the update time of a pertinent page with update time values of each group by use of the group management table (S101). If the requested data writing is the new data writing, it is impossible to estimate the update time. Accordingly, the new data is stored at the block that is not included in the group (S103 and S105). In contrast, if the requested data writing is previous data updating, it is possible to invalidate a page in which the previous data has been stored and calculate the update time of the page (S107). Moreover, the allocator 12 can search the group management table in order to check whether there is a group entry corresponding to the calculated update time. If there is the group entry corresponding to the calculated update time, the allocator 12 can check whether there is a blank page in a pertinent group (S109 and S111). If there is the blank page in the group, the updated data can be stored at a pertinent page (S113). If there is no blank page in the group, the allocator 12 can allocate a new block and add the allocated block to store the updated data (S115 and S117). If there is no group corresponding to the calculated update time, the updated data can be stored at the block that is not included in the group.

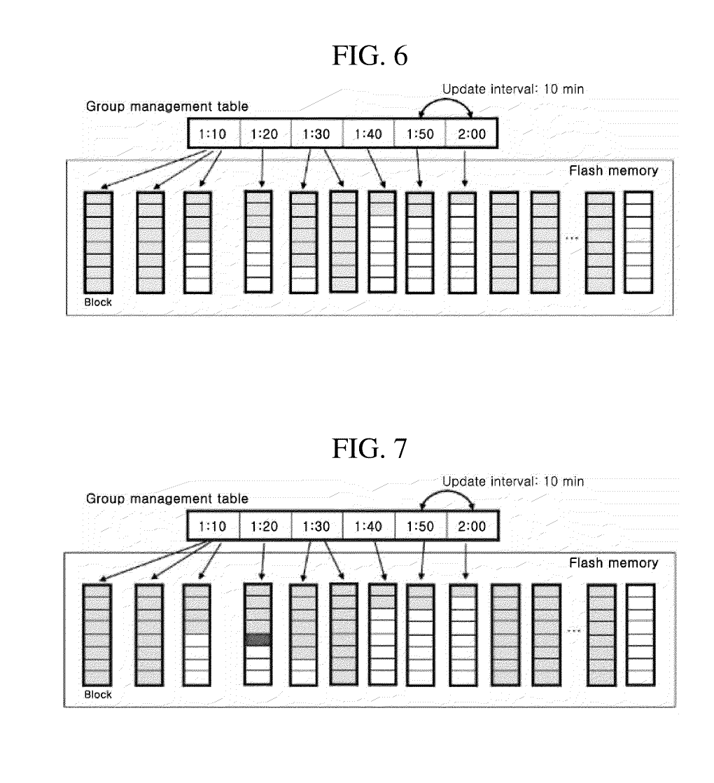

FIG. 6A and FIG. 6B show a write operation when the update time of a write-requested page corresponds to an entry in a group management table. It is assumed that the number of entries of table is 6 and the update time interval of each group entry is 10 minutes. For example, when the update time of a page that receives the request of the data writing is 1:18, the page can be allocated to the second entry of the table having the update time of group of 1:20.

In the group management table, a user must determine the number of groups and the update time interval of group optionally. If all data of the flash memory is managed per group, the overhead is too large. It is not meaningful to manage the data in which little update is performed per group. Accordingly, the data that is to be updated within a certain period of time can be managed by using the limited number of groups. At this time, the data in which no update is performed and the data that can be updated but is unable to pertain to the group due to the long expected update time can follow the typical writing operation method. In accordance with an embodiment of the present invention, the experiment has measured the change of performance of the clustering method for the flash memory according to the number of groups. The update time interval of group refers to a value determining the update time of each group. If the update time internal of group is widely determined, this may widen the update time intervals of pages that are to pertain to the same group, thereby increasing the possibility that there are more valid pages in the pertinent block when the erase operation is performed. Accordingly, the block copy cost may be increased. In contrast, if the update time interval of group is narrowly determined, this may enable the group update time to be subdivided, thereby decreasing the number of the pages which are to pertain to the same group. Accordingly, many blocks having a lot of blank pages may be erased. Thus, it is important to determine an adequate value.

In the experiment, the capacity of the flash memory is determined on the basis of the 1 G NAND flash memory, and the CAT is used as the cleaning policy. The data used for the experiment is based on the data having regular update times.

Moreover, random data and locality data having 4 locality types are used to measure the performance of various data. In particular, the locality data, 90/10, 70/10, 50/10, 30/10, and 10/10 and the random data 10/10 are used. The locality data 90/10 indicates that 90% of the operation is focused on 10% of the data and the remainder 10% of the operation is focused on 90% of the data. The locality data 70/30 indicates that 70% of the operation is focused on 10% of the data and the remainder 30% of the operation is focused on 90% of the data.

The probability density function of exponential random variables was used in order to generate the locality data. The probability density function satisfies the formula 2.

$${f}_{x} ( x ) = \{ \begin{matrix}{λe}^{- λ x} & x \geq 0 \\ 0 & otherwise\end{matrix} \qquad [ Formula 2 ]$$

A λ value can be found by integrating the probability density function of exponential random variables of the formula 2 and the locality data can be created by determining the frequency per each page and adjusting the magnitude of the inverse number of the frequency. FIG. 7 shows the frequency according to page number in the 1 G byte.

In the experiment, the data is successively stored at 90% of the flash memory in order to initiate the flash memory. At least 2% vacant space of the flash memory is maintained. The time at which the experiment is performed is based on the time after the page is updated 40 billion times. The total frequency of the erase operation and the average block copy cost is measured after the page is updated 40 billion times as the standard of measuring the performance of the experiment. Moreover, the erase cost of the following formula 3 can be used in consideration of the weight (writing: 1, erasing: 10) of the write and erase operations.

Erase cost=(Average block copy cost+10)×Frequency of erase operation [Formula 3]

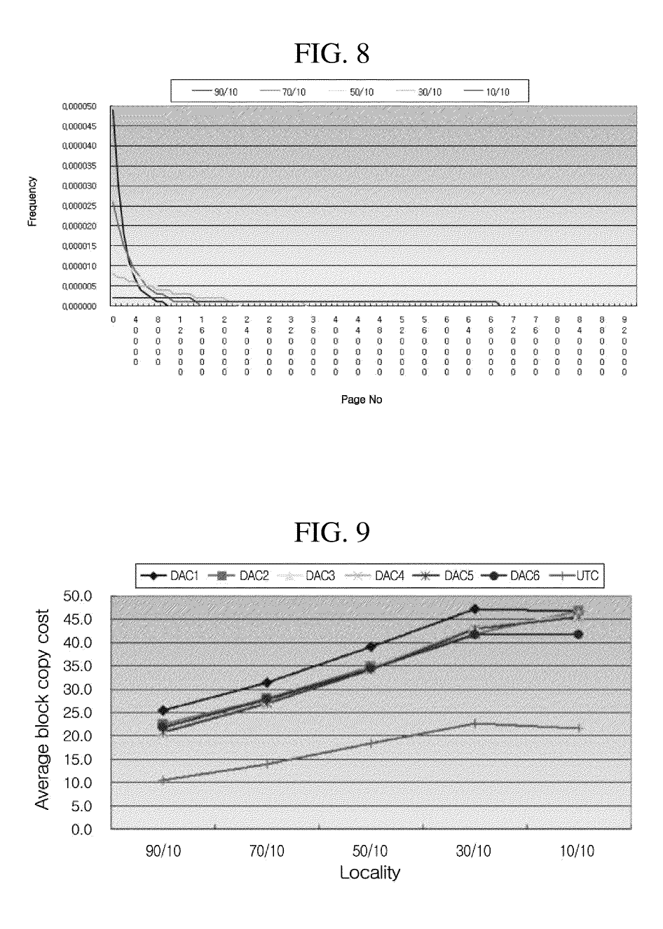

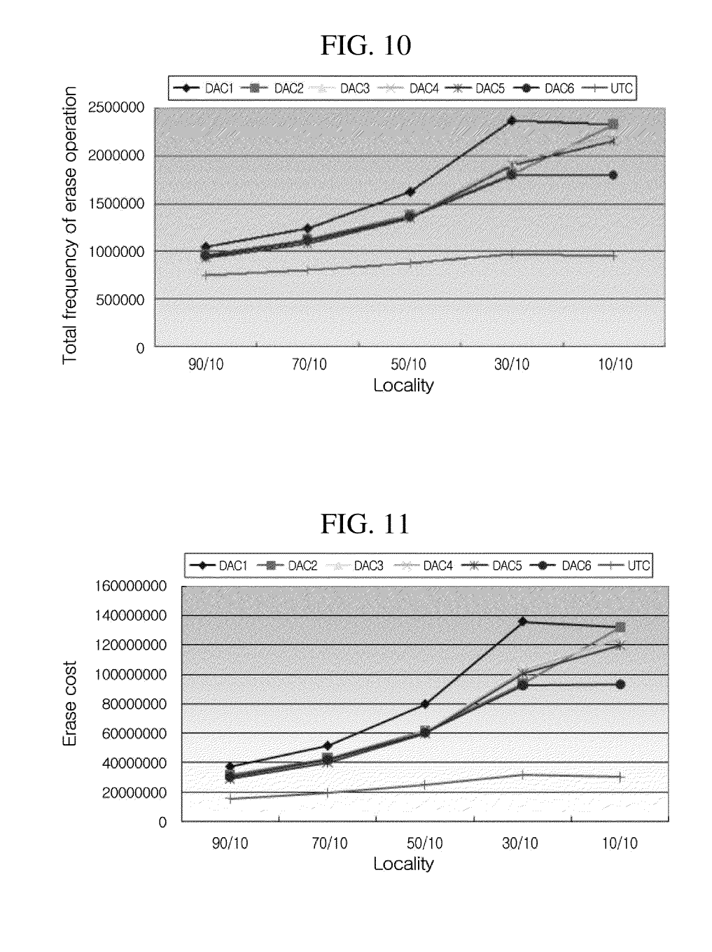

Moreover, in order to compare the performances of the dynamic data clustering method and the clustering method for the flash memory according to an embodiment of the present invention, it is possible to measure the performances of the expected-update-time-based clustering method and the hot data clustering method, which is the existing data clustering method of the flash memory. The DAC is selected among the hot data clustering methods as the comparison target of the clustering method for the flash memory in accordance with an embodiment of the present invention. Since the performance of the DAC is significantly changed according to the number of legions and time threshold values, a total of 6 environments are used. The parameters can be determined through the following table 1. Since the DAC1 method does not divide the regions, the DAC1 method is the representative writing method of a typical flash memory. The expected-update-based clustering method (UTC) determines the size of table as 16 and the update time interval of group as 20. The result is shown through FIG. 8 to FIG. 10.

TABLE 1

| | DAC | | | | | |
|---|---|---|---|---|---|---|
| Parameter | DAC1 | DAC2 | DAC3 | DAC4 | DAC5 | DAC6 |
| Number. of | 1 | 4 | 2 | 4 | 8 | 8 |
| legions | | | | | | |
| Time threshold | — | 30 | 120 | 120 | 120 | 60 |

As shown in FIG. 8 through FIG. 10, as compared with the DAC method, the clustering method in accordance with an embodiment of the present invention shows better performance, such as the average block copy cost of 54% at the maximum, the frequency of the erase operation of 59% at the maximum, and the erase cost of 77% at the maximum. Moreover, while the performance of the DAC is significantly changed according to the localities, the difference of performances according to the localities is smaller in accordance with an embodiment of the present invention. Since the period of all data having the locality 10/10 is greater than the time threshold of the DAC2, the clustering method according to an embodiment of the present invention has the same result as that of the DAC1 regardless of the determined number of legions of the DAC2. The DAC 3, the DAC 4, and the DAC 5 have the same time threshold, thereby showing similar pattern generally.

In the experiment, measuring the change of performance of the expected-update-time-based clustering method, the environment variables are added to precisely measure the performance through various experiments. The following table 2 shows the update time intervals of group and the number of groups, used in the experiment.

TABLE 2

| Environment variable | Environment variable value |
|---|---|
| Update time interval of group | 1, 5, 10, 20, 40, 80, 160, 320 |
| Number of groups | 1, 4, 8, 16, 32, 64, 128 |

Here, when one certain parameter value is changed as the representative parameter, another environment value is fixed as the representative value. For example, when the experiment is performed changing the update time interval of group in the order of 1, 5, 10, 20, 40, 80, 160, and 320, the number of groups is fixed as 16. The target data of the experiment is the data having the locality 90/10.

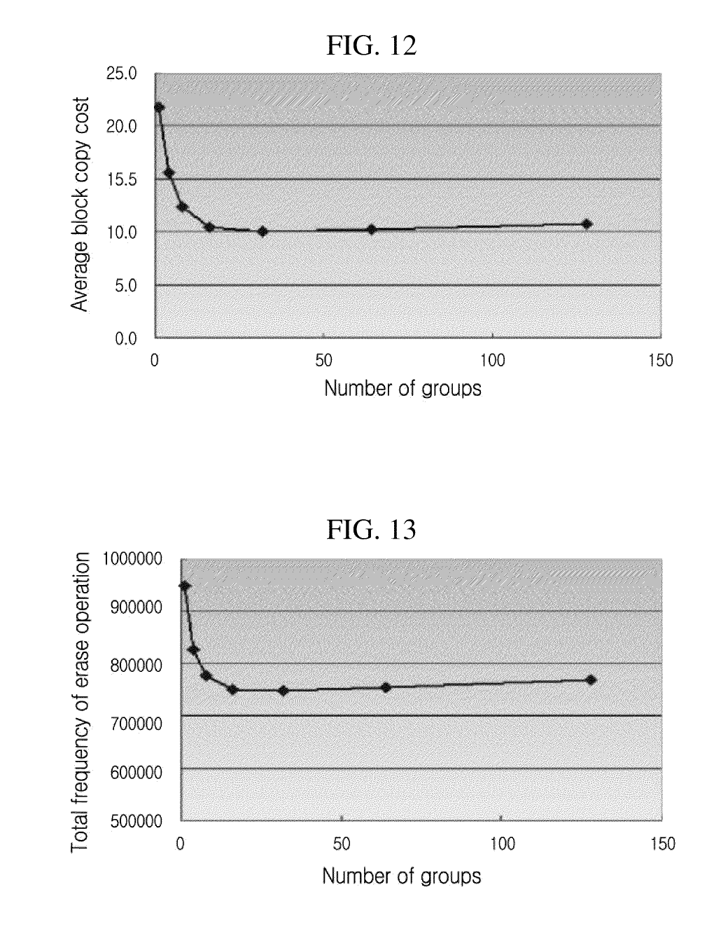

A first experiment measures the change of performance of the expected-update-time-based clustering method according to the change of the number of groups when the update time interval of group is fixed. The result is shown through FIG. 11 to FIG. 13. Here, the number of groups up to 16 shows the rapid changes of performance, but the number of groups after 16 shows little change of performance. Since the more groups there are, the more groups the group management table can manage, the high clustering effect is expected. However, it is sufficient to manage some data having short update time intervals in order to show the clustering effect that is strong enough. This reflects that the changes of performance according to the number of groups are not significantly recognized.

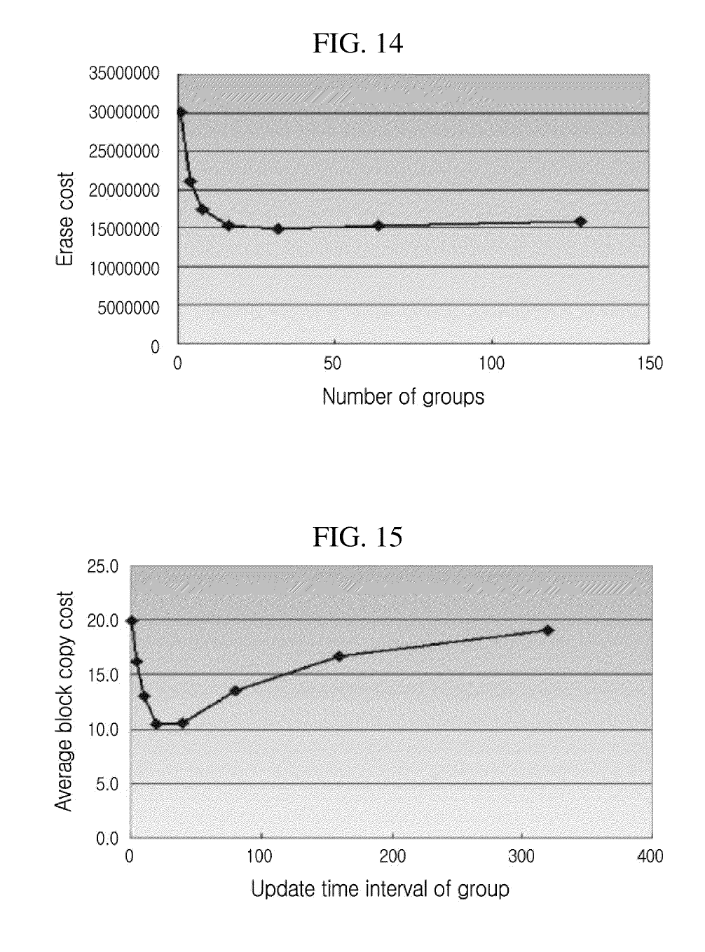

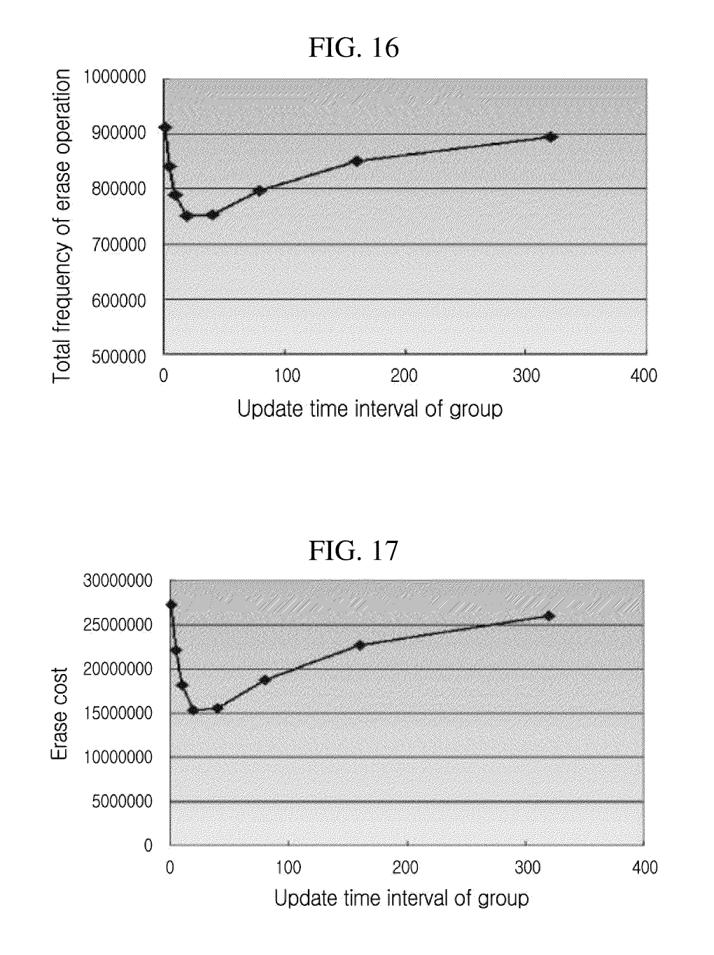

A second experiment measures the change of performance of the expected-update-time-based clustering method according to the change of the update time interval of group when the number of groups is fixed. The result is shown through FIG. 14 through FIG. 16. The result shows that the best performance at the update time intervals of 20 and 40 and the smoothly increasing performance at the following values. This is because if the update time interval of group has a great value, the worst case has no clustering effect. Accordingly, it is important that a user determines the update time interval of group as an adequate value according to the localities of the data.

The above detailed descriptions are only examples of the present invention, and a variety of modifications and forms can be made from such examples in the present invention. Thus, the detailed descriptions serve only for describing the present invention and by no means limit or restrict the spirit and scope of the present invention. It shall be understood that a large number of permutations and other equivalent embodiments are possible. The true scope of the present invention must be defined only by the spirit of the appended claims.

What is claimed is:

1. A clustering device for a flash memory, the device gathering pages having similar update times and performing a write operation of the pages in a same block.

2. The device of claim 1, wherein, if there are some data having different update periods in a same page, an update period of the page becomes identical to that of data having a shortest update period.

3. The device of claim 1, the device comprising:
an allocator, configured to allocate a page that is to store data on the basis of a group management table, if a write operation is requested; and
a cleaner, configured to erase a block selected by an erase policy, if an erase operation is requested.

4. The device of claim 3, wherein the group management table manages a plurality of group entities and comprises a group update time and a list of the blocks of the group.

5. The device of claim 4, wherein the group is a set of blocks storing pages having similar update times, and one group corresponds to one group management table entry.

6. The device of claim 5, wherein, if a page Pj is updated, the page Pj is stored at a group entry Ei that satisfies the following formula:
Eᵢ₋₁.updatetime<Pⱼ.updatetime≦Eᵢ.updatetime

7. A clustering method for a flash memory, the method comprising:
checking whether data writing is new data writing or previous data updating, if the data writing is requested;
invalidating a page in which previous data has been stored and calculating an update time of a pertinent page, if it is checked that the data writing is the previous data updating;
checking whether there is a blank page in a group corresponding to the calculated update time, if there is the group; and
storing the updated data at the blank page if there is the blank page.

8. The method of claim 7, further comprising allocating a new block and adding the block into the group, if there is no blank page,
wherein the updated data is stored at a blank page of the added block.

9. The method of claim 7, further comprising storing the updated data at a blank page of a block that is not included in the group, if there is no group entry corresponding to the calculated update time.

10. The method of claim 7, wherein, if it is checked that the data writing is the new data writing, the data is stored at a blank page of a block that is not included in the group entry.

11. A clustering method for a flash memory, the method comprising:
invalidating a page in which previous data has been stored and calculating an update time of a pertinent page, if data writing is requested; and
checking whether there is a group corresponding to the calculated update time and storing updated data at a blank page if there is the group.

12. The method of claim 11, further comprising allocating a new block and adding the allocated block into the pertinent group, if there is no blank page in the pertinent group.

13. The method of claim 11, further comprising storing the updated data at a block that is not included in the group, if there is no pertinent group.
